(19) United States
(12) Patent Application Publication
(10) Pub. No.: US 2007/0279230 A1
(43) Pub. Date: Dec. 6, 2007

(54) System and Method for Attaching Radiofrequency Identification Chips to Metalized Antenna

(75) Inventors: Russell Ernest Lakeman, San Jose, CA (US); Rocky Richard Arnold, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wavezero, Inc., Sunnyvale, CA (US)

(21) Appl. No.: 11/753,418

(22) Filed: May 24, 2007

Related U.S. Application Data
(60) Provisional application No. 60/810,388, filed on Jun. 1, 2006.

(51) Int. Cl. G08B 13/14

(52) U.S. Cl. 340/572.7; 340/572.8

(57) ABSTRACT

An RFID antenna that is protected from corrosion and is configured for easy attachment to an electronic chip is very advantageous. The electrically conductive RFID antenna pattern is coated with a layer of solderable material that protects the copper from corroding. The solderable material has a low melting temperature so that the solderable material can be heated to form a weld joint between a chip and the solderable material without damaging the chip.

### CROSS-REFERENCES TO RELATED APPLICATIONS

This application claims the benefit of U.S. Provisional Application No. 60/810,388, filed Jun. 1, 2006, which is incorporated herein by reference in its entirety for all purposes.

### BACKGROUND OF THE INVENTION

The present invention relates generally to radiofrequency identification (RFID) tags and in particular to attaching a radiofrequency identification chip (RFIC) to an RFID antenna. The present invention also enables a method to protect the metal coating of an RFID antenna from the environment.

RFID tags typically use copper or aluminum coatings as the functional elements of the antennas. The antennas are made by creating metal coating patterns on a substrate. Antennas are an essential part of a radio communication device, such as RFID tag, because they are used to either receive or transmit radiofrequency signals. When aluminum is used as a coating a self-stabilizing layer of oxidation forms which helps protect the coating from degradation due to the environment. However, when copper is used instead of aluminum, the oxidation or corrosion may not be self limited. Over time, harmful non-metallic transformation of the copper coating can occur. Therefore, copper RFID tag antennas can corrode over time and can change their performance characteristics.

Additionally, RFID antennas have a chip attached to the antenna to control the receiving and transmission of radiofrequency signals. In addition to controlling the receiving and transmission of radiofrequency signals, the electronic chip can be made to process signals. Attaching these electronic chips to a metal coating (to make a complete unit of IC and antenna) can be costly and can increase the cost of making copper RFID antennas. If an antenna oxidizes and corrodes, it is even more costly to attach an electronic chip to the antenna because the corrosion can interfere with the attachment. The use of conductive adhesives, which is common, also adds to the cost of the process especially when corrosion has occurred because of the interaction between the adhesive and the corrosion.

Therefore, what is needed is an RFID antenna that (1) facilitates the attachment of an RFIC and (2) provides for environmental protection.

### BRIEF SUMMARY OF THE INVENTION

Embodiments of the present invention provide an RFID antenna that can easily be attached to an electronic chip and has corrosion protection, in the case of copper and additional protection in the case of aluminum or similar conducting material. The RFID antenna pattern is coated with a layer of solderable material that protects the copper from corroding. The solderable material has a low melting temperature so that the solderable material can be heated to form a weld joint between a chip and the solderable material without damaging the chip or antenna.

In one embodiment of the present invention, an RFID antenna includes a copper, aluminum, or metal element forming the antenna with a layer of metal material that behaves like solder (e.g., solderable material) over the copper element.

In another embodiment of the present invention, the layer of solderable material is directly over the earlier deposited metal coating(s)

In yet another embodiment of the present invention, the layer of solderable material is in direct contact with the metal coating element.

In yet another embodiment of the present invention, the layer of solderable material substantially encloses the copper, aluminum, or metal or organic conducting element.

In another embodiment of the present invention, an RFID antenna includes a copper, aluminum, metal, or organic conducting element forming the antenna, a layer of solderable material over the copper element for protecting the copper element from corrosion, and a chip for controlling the antenna, wherein the chip is attached to solderable material though a weld joint between the solderable material and the chip. In another embodiment of the present invention, the layer of solderable material is directly over the copper element. In another embodiment of the present invention, the layer of solderable material is in direct contact with the copper element. In another embodiment of the present invention, the layer of solderable material substantially encloses the copper element.

In another embodiment of the present invention, an RFIC includes a solderable material for forming a weld joint between the RFIC and an RFID antenna, and a conductive element for transferring energy to the solderable material for melting the solderable material and forming a weld joint between the RFIC and the RFID antenna. The conductive elements are integral to the RFIC and run through the RFIC.

In yet another embodiment of the present invention, the conductive element is a thermal conductor.

In yet another embodiment of the present invention, the conductive element is an electrical conductor.

In yet another embodiment of the present invention, the conductive element is copper.

In yet another embodiment of the present invention, the conductive element is a column connecting the top of the RFIC with the bottom of the RFIC so that energy flows from the top of the column to the bottom of the column causing the solderable material to melt and form a weld joint.

In another embodiment of the present invention, a method of making an RFID antenna includes forming an RFID antenna pattern on a substrate, wherein the RFID antenna pattern is copper, aluminum, metal or organic conductor and depositing a layer of solderable material over the conductive layer using vacuum metallization.

In yet another embodiment of the present invention, the method includes depositing the layer of solderable material directly over the copper, aluminum, metal, or organic conductor.

In yet another embodiment of the present invention, the method includes depositing the layer of solderable material to completely cover the copper, aluminum, metal, or organic conductor.

In another embodiment of the present invention, a method of making an RFID antenna includes creating an RFID antenna pattern on a substrate, wherein the RFID antenna pattern is electrical conductive, depositing a layer of solderable material over the electrically conductive layer using vacuum metallization, placing a chip on the solderable material, heating the solderable material and the chip until the solderable material reaches a solderable material melting temperature, and forming a weld joint between the solderable material and the chip electrical attachment points (e.g., bumps). The solderable material melting temperature is lower than a substrate melting temperature or the application time of the heat required to melt the solderable material is less than the time required to damage or distort the substrate. The solderable material can be heated to a temperature that is lower then a substrate glass transition temperature or the solderable material temperature may be higher provided the duration of heat application is insufficient to damage the substrate. The weld joint can be formed by cooling the solderable material to below the solderable material melting temperature.

In yet another embodiment of the present invention, the solderable material is heated to the melting temperature by driving a current through the RFID antenna pattern causing the temperature of the solderable material to increase above the melting temperature and flowing.

In yet another embodiment of the present invention, the method of making an RFID antenna further includes printing with a silver conductive ink a starting metallization pattern onto which electroplating can be applied.

In another embodiment of the present invention, a method of making an RFID antenna includes forming an RFID antenna pattern on a substrate, wherein the RFID antenna pattern is a conductive material, depositing a layer of solderable material over the conductive material using vacuum metallization, heating the solderable material to a solderable material melting temperature, placing a chip on the solderable material while the temperature of the solderable material is near the solderable material melting temperature, and forming a weld joint between the solderable material and the chip. The solderable material melting temperature is lower than the substrate melting temperature. The solderable material can be heated to a temperature that is lower then a glass transition temperature of the substrate or higher if provision is made to minimize damage to the substrate by minimizing time or enabling a cooling mechanism. The weld joint can be formed by cooling the solderable material to below the solderable material melting temperature. The solderable material can be heated to the melting temperature by driving a current through the RFID antenna pattern conductor. Additionally, a starting metallization pattern made of silver conductive ink can be printed onto the substrate and electroplating can be applied to this printed pattern.

The following detailed description, together with the accompanying drawings will provide a better understanding of the nature and advantages of the present invention.

### BRIEF DESCRIPTION OF THE DRAWINGS

FIG. 1A is a cross-sectional view of an RFID antenna with a solderable material coating and attached chip, in accordance with an embodiment of the present invention.

FIG. 1B is a top view of an RFID antenna with a solderable material coating and attached chip, in accordance with an embodiment of the present invention.

FIG. 2A illustrates an apparatus used to attach a chip to an RFID antenna via a solderable material coating, in accordance with one embodiment of the invention.

FIG. 2B illustrates another configuration used to attach a chip to an RFID antenna via a solderable material coating where heating is supplied through the conductive antenna, in accordance with one embodiment of the invention.

FIG. 2C illustrates an RFIC configured to deliver energy to solderable material for forming a weld joint between the RFIC and an RFID antenna, in accordance with one embodiment of the invention.

FIG. 3 is a flowchart illustrating a method for making an RFID antenna with a solderable material coating, in accordance with one embodiment of the invention.

FIG. 4 is a flowchart illustrating a method for making an RFID antenna with a solderable material coating and an attached chip, in accordance with one embodiment of the invention.

FIG. 5 is a flowchart illustrating another method for making an RFID antenna with a solderable material coating and an attached chip, in accordance with another embodiment of the invention.

### DETAILED DESCRIPTION OF THE INVENTION

An RFID antenna that is protected from corrosion and is configured for easy attachment to an electronic chip is very advantageous. The present invention provides a metalized RFID antenna that can easily be attached to an electronic chip and has corrosion protection. The metalized RFID antenna pattern is coated with a layer of solderable material that protects the conductive coating from corroding. The solderable material has a low melting temperature so that the solderable material can be heated to form a weld joint between a chip and the solderable material without damaging the chip or substrate.

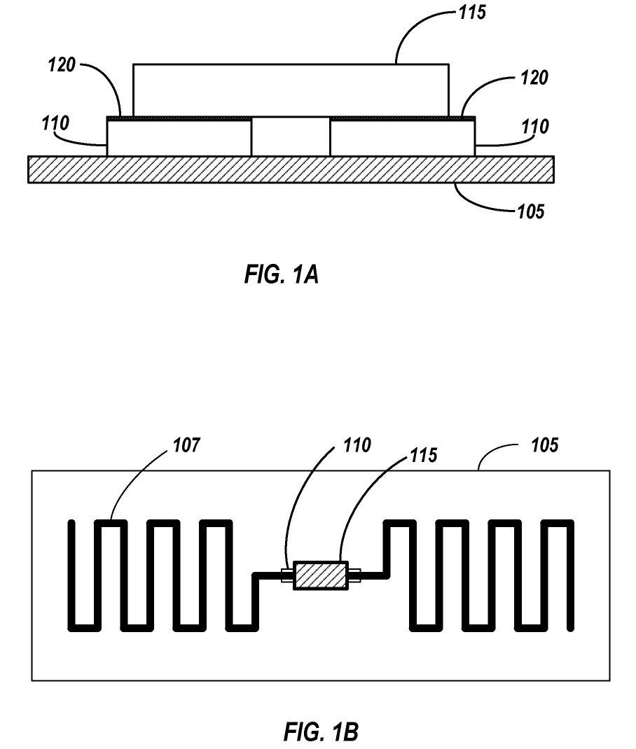

FIG. 1A is a cross-sectional view of an RFID antenna with a solderable material coating including substrates/films 105, patterned metal layers including a solderable material layer 110, a chip 115, and weld joints 120, in accordance with an embodiment of the present invention. Substrate/films 105 can include the substrate by itself or the substrate and several layers of materials deposited on the substrate. The layers deposited on the substrate in substrate/film 105 can be seed layers, barrier layers, adhesion layers, etc. The patterned metal layers including the solderable material layer 110 further includes the RFID pattern, which is usually a metal but can be a conductive organic material that has been laid down according to a pattern. The solderable material layer is a thin layer of solderable material which has been deposited over the copper. In one embodiment the solderable material is made of Tin Bismuth. In other embodiments other materials are used. For example, materials used in the high volume automated processes for solderable material attachment can be used whether the materials are leaded solderable material or no-lead solderable material such as SAC (Tin-Silver-Copper) amalgams in various proportions of the constituents. Chip 115 is a controller used to operate the RFID antenna and can include memory for storing data as well as transistors and other circuit elements arranged to process data. Chip 115 is attached directly onto the metal layers including the solderable material layer 110 via the weld joints 120.

Solderable material layer 110 protects the metal coating surface by covering it. In some embodiments the entire metal coating surface is encapsulated with solderable material layer 110, whereas in other embodiments only portions of the metal coating surface is covered with solderable material.

FIG. 1B is a top view of an RFID antenna with a soldered RFIC including substrates/films 105, and RFID antenna pattern 107, a solderable material layer 110, and an RFIC 115, in accordance with an embodiment of the present invention. The antenna pattern 107 is formed on top of the substrate/films 105 and is made of copper, aluminum, metal, or organic conductor. The antenna pattern can be made by first depositing a layer of the copper, aluminum, metal, or organic conductor, masking the layer to and then etching away the unmasked portions of the layer. When the mask is removed, the antenna pattern remains. The solderable material layer 110 is deposited directly over the copper, aluminum, metal or organic conductor layer. In one embodiment of the invention the solderable material is etched along with the copper, aluminum, metal or organic conductor layer so that the solderable material layer remains on top of the entire antenna. In another embodiment, only some portions of the antenna are left with the solderable material layer. In FIG. 1B the solderable material 110 is shown only around the RFIC 115 which has been attached to the antenna. Solderable material 110 is shown to extend beyond the antenna because of the reflow which occurs when the solderable material is melted. Achieving the correct temperature at the solderable material-RFIC bump junction is a matter of optimizing the combination of temperature, heat, and time. The temperature, heat, and time are adjusted so that the solderable material located at the bump interface just melts and forms the weld bond between solderable material and RFID bumps. In one embodiment, the amount of time is minimized to avoid thermal damage to the underlying substrate or RFIC. In one embodiment the heating is done from the bottom (i.e., the surface opposite to the surface metalized) whereas in another embodiment the heating is done from the top (as with a forced air heat gun). Still in another embodiment, heating can be done from both the top and the bottom.

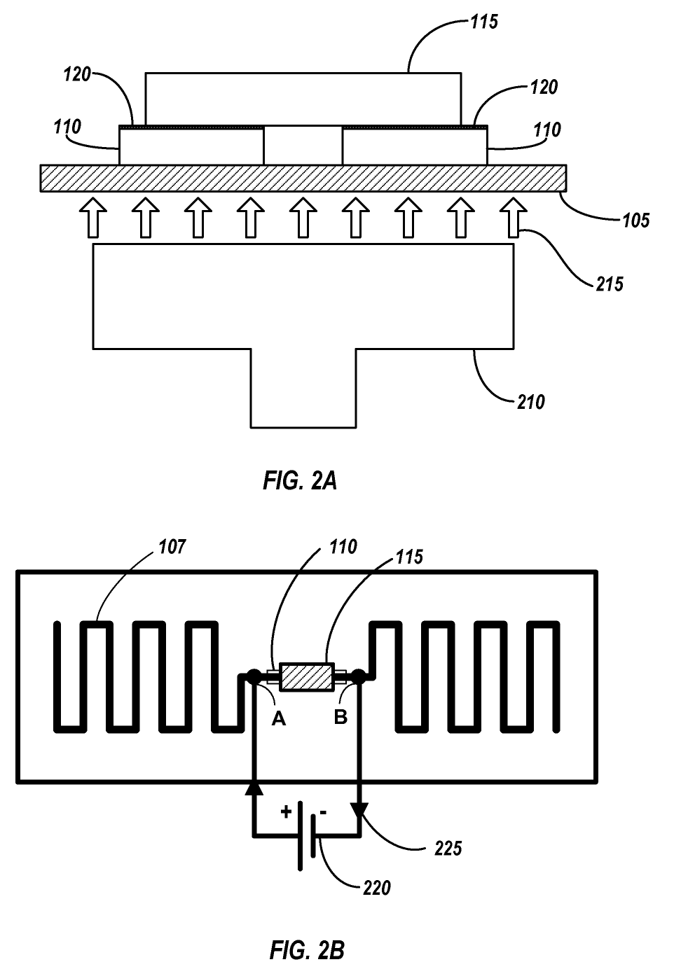

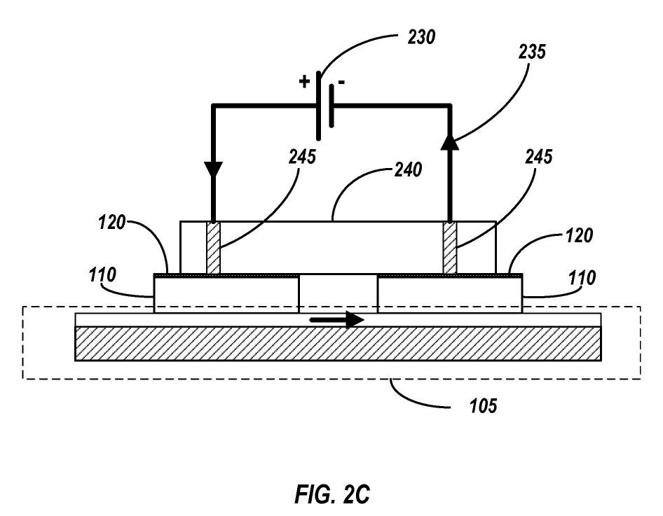

FIG. 2A illustrates an apparatus used to attach the chip 115 to the metal layers including the solderable material 110 via the weld joints 120 including a heater 210 and heat energy 215, in accordance with one embodiment of the invention. Heater 210 supplies energy, which is illustrated as heat energy 215, to the substrate/film 105. Heater 210 is a heater capable of supplying sufficient heat the raise the temperature of the solderable material above the melting temperature so that it begins to flow. Heater 210 can be a resistive heater, an infrared heater, a radiant heater, a laser heater, etc. In one embodiment heater 210 is a pulse heater that heats from the back side of the substrate/film 105 melting the solderable material creating a weld joint. In another embodiment infrared heating or radiant heating is used because the melt temperature of the solderable material is lower than the glass transition temperature of the substrate/film 105. In another embodiment heater 210 is a resistive element heater that is attached to a power supply that can provide pulses of power to the resistive heating elements.

FIG. 2B illustrates another configuration used to attach the chip 115 to the metal layers of the antenna pattern 107 including the solderable material 110 via weld joints (not shown) including a battery 220 and current 225, in accordance with one embodiment of the invention. Battery 220 is attached to the metal layers of the antenna and provides a voltage drop between points A and B. As current flows through the metal layers of the antenna between points A and B, the metal layers heat up by resistive heating causing the solderable material which is in contact with the metal layers to also heat up. The voltage drop between points A and B can be adjusted depending on the resistance of the metal layers so that the appropriate amount of heat is dissipated to melt the solderable material. This configuration acts like a resistive element heater but takes advantage of the metal layers in the conductive antenna that are in close proximity to the solderable material that is melted. Therefore, in this embodiment electrical energy (i.e., current) is caused to be driven into the metalized coating and through resistive heating, the solderable material is brought to the melting temperature causing the solderable material to begin flowing and cooling forming a joint.

FIG. 2C illustrates another configuration used to attach the chip 240 to the metal layers of the antenna pattern. In this configuration the chip 240 is configured with a conductive element 245 (two shown) used to transfer energy to the solderable material 110 causing the solderable material 110 to melt and form a weld joint 120. The underside bump used for electrical conductivity is connected through the chip 240 with a conductive element 245 column of highly conductive material like copper so that by heating the top of the column of copper, the bottom of the column (e.g., the bump) is caused to warm and thus melt the solderable material. If electrical current is used to heat the solder then a battery 230 is used to transfer heat to the solder by running current through the conductive elements 245 to the solder causing the solder to heat up. Additionally, the metal in the conductive antenna located in the substrate/film 105 can be used to also carry current and form a complete circuit.

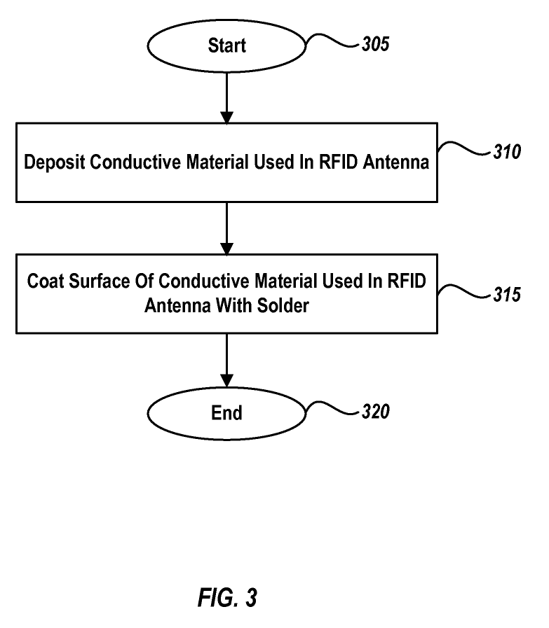

FIG. 3 is a flowchart illustrating the basic steps used to make the solderable material coated RFID antennas. The process starts in step 305 where a substrate is provided. The substrate can be made of glass, ceramic, metal, paper, polymers, etc. The substrate can further include one or more layers that are used as seed layers, barrier layers, adhesion layers etc. In step 310 a metal coated RFID antenna is formed on the substrate. This RFID antenna can be done by depositing layers of copper, aluminum, metal, or organic conductor and then forming the antenna pattern by using masking and etching techniques. Once the antenna pattern has been laid down using a conductive material, the conductive material layer is coated in step 315 with a thin layer of solderable material. The thickness of the solderable material can range between several microns to tens of microns. The solderable material can be lead free solderable material such as Tin Bismuth SAC, or any number of industry accepted leaded or no-lead solderable materials. Additionally, the solderable material can be deposited using vacuum metallization processes such as vaporization techniques, sputtering, evaporation, physical vapor deposition, chemical vapor deposition, ion bean deposition, or other techniques such as electroplating or electroless plating in which an initial vapor deposited layer is used a prerequisite to heavier depositions of metal. In other embodiments, a starting metallization pattern made of silver conductive ink is printed onto the substrate. Electroplating can then be applied to the silver conductive ink to the form then antenna. Finally in step 320 the process ends by preparing the RFID antenna for subsequent processing such as the application of a chip to the RFID antenna.

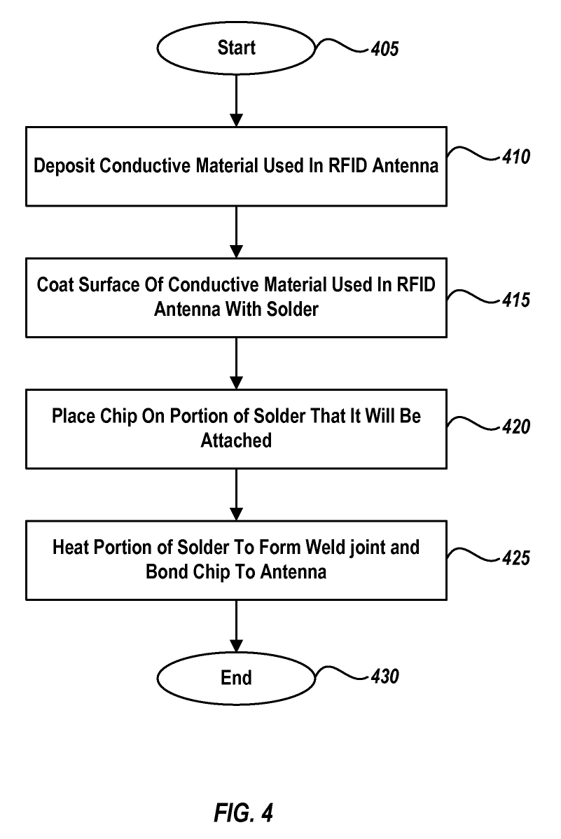

FIG. 4 is a flowchart illustrating the basic steps used to make solderable material coated RFID antennas with attached chip, in accordance with one embodiment of the invention. The process starts in step 405 where a substrate is provided. As described above, the substrate can further include one or more layers that are used as seed layers, barrier layers, adhesion layers etc. In step 410 an RFID antenna made of copper, aluminum, metal, or organic conductor is deposited using vaporization techniques and patterning techniques. Once the antenna pattern has been laid down using copper, the copper layer is coated in step 415 with a thin layer of solderable material. Deposition thicknesses can range from several microns to tens of microns depending upon the intended application. For instance, an HF RFID inlay would have thicker depositions because of the lower frequency of transmission while an UHF antenna, which operates at higher frequencies, could have thinner depositions. The solderable material can be lead free solderable material such as Tin Bismuth and it can be deposited using vacuum metallization processes. Next in step 420, the chip is placed on the solderable material at the location where the chip is to be bonded to the solderable material. Next in step 425, heat is added to the solderable material so that the solderable material melts and forms a weld joint between the solderable material and the chip. The amount of heat added to the solderable material is sufficient to raise the temperature of the solderable material above the melting point so the weld joint can be made. The amount of heat to be added will vary depending on the application because factors like thermal mass and conductive properties of the solderable material as well as the efficiency of the heating process will have effects on the heating process. Heating can be accomplished with simple conductive methods (i.e., heat gun or heated platen), radiofrequency excitation (like microwave), as well as numerous other means. The heating method should be chosen to create the right conditions at the bump-solderable material attachment point, while at the same time not causing differential thermal expansion that causes materials to deform beyond their limit points for elastic behavior. Additionally, the amount of heat added to the solderable material is less then would raise the temperature of he substrate/film above the glass transition temperature. For example, the temperature of the interface between the RFID bump and solderable material would be around 160° C. However, those skilled in the art will realize that this temperature will vary according to the type of solderable material, method of heating, and mechanical properties of the substrate with temperature and heat. Since the melting temperature of the solderable material is lower than the glass transition temperature of the substrate/film, heat can be supplied by infrared heating or radiant heating. Moreover, since the chip is in contact with the solderable material, care must be taken to keep the chip from overheating during the solderable material melting process. Finally in step 430 the RFID antenna, along with the attached chip, is cooled and removed from the heater where it can be sent on for further processing, if needed.

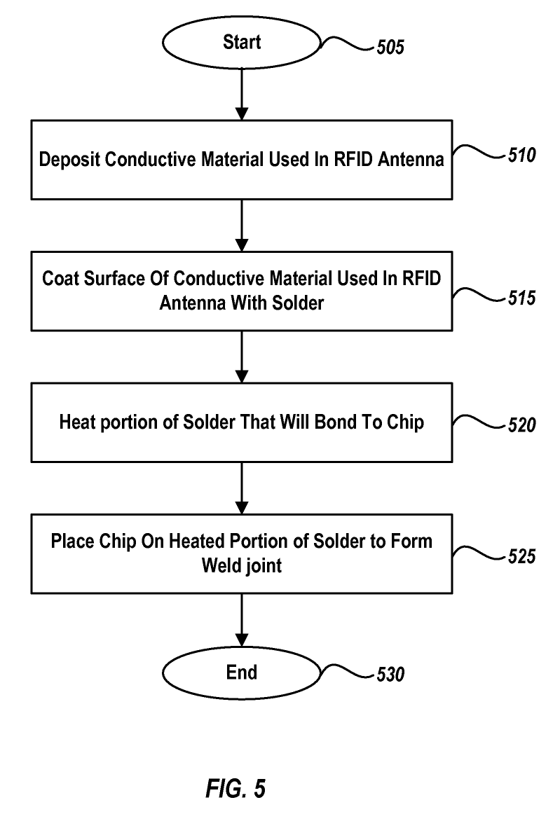

FIG. 5 is a flowchart illustrating another embodiment of the steps used to make solderable material coated RFID antennas with attached chips. The process starts in step 505 where a substrate is provided. As described above, the substrate can further include one or more layers that are used as seed layers, barrier layers, adhesion layers etc. In step 510 an RFID antenna made of conductive material is deposited using vaporization techniques and patterning techniques. Once the antenna pattern has been laid down using a conductive material, the conductive layer is coated in step 515 with a thin layer of solderable material. The solderable material can be lead free solderable material such as Tin Bismuth and it can be deposited using vacuum metallization processes. In step 520, heat is added to the solderable material so that the solderable material melts and forms a weld joint between the solderable material and the chip. The amount of heat added to the solderable material is sufficient to raise the temperature of the solderable material above the melting point so the weld joint can be made. Additionally, the amount of heat added to the solderable material is less than would raise the temperature of the substrate/film above the glass transition temperature. Since the melting temperature of the solderable material is lower than the glass transition temperature of the substrate/film, heat can be supplied by infrared heating or radiant heating. Next in step 525, the chip is placed on the solderable material at the location where the chip is to be bonded to the solderable material. Finally in step 530 the RFID antenna along with the attached chip is cooled and removed from the heater where it can be sent on for further processing, if needed. Since this embodiment only heats the RFID antenna, with the solderable material and the chip, later added, damage to the chip from overheating can be reduced.

It will also be recognized by those skilled in the art that, while the invention has been described above in terms of preferred embodiments, it is not limited thereto. Various

What is claimed is:

1. An RFID antenna, comprising:
a conductive element forming said antenna; and
a layer of solderable material over said conductive element.

2. The RFID antenna of claim 1 wherein said layer of solderable material is directly over said conductive element.

3. The RFID antenna of claim 1 wherein said layer of solderable material is in direct contact with said conductive element.

4. The RFID antenna of claim 1 wherein said layer of solderable material substantially encloses said conductive element.

5. An RFID antenna, comprising:
a conductive element forming said antenna;
a layer of solderable material over said conductive element for protecting said conductive element from corrosion;
and a chip for controlling said antenna, said chip attached to solderable material though a weld joint between said solderable material and said chip.

6. The RFID antenna of claim 5 wherein said layer of solderable material is directly over said conductive element.

7. The RFID antenna of claim 5 wherein said layer of solderable material is in direct contact with said conductive element.

8. The RFID antenna of claim 5 wherein said layer of solderable material substantially encloses said conductive element.

9. An RFIC, comprising:
a solderable material for forming a weld joint between the RFIC and an RFID antenna;
a conductive element for transferring energy to the solderable material for melting the solderable material and forming a weld joint between the RFIC and the RFID antenna; and
features and aspects of the above-described invention may be used individually or jointly. Further, although the invention has been described in the context of its implementation in a particular environment and for particular applications, those skilled in the art will recognize that its usefulness is not limited thereto and that the present invention can be utilized in any number of environments and implementations.
wherein said conductive elements are integral to said RFIC and run through said RFIC.

10. The RFIC of claim 9 wherein said conductive element is a thermal conductor.

11. The RFIC of claim 9 wherein said conductive element is an electrical conductor.

12. The RFIC of claim 9 wherein said conductive element is copper.

13. The RFIC of claim 9 wherein said conductive element is a column connecting a top of the RFIC with a bottom of the RFIC so that energy flows from the top of the column to the bottom of the column causing the solderable material to melt and form a weld joint.

14. A method of making an RFID antenna, comprising:
forming an RFID antenna pattern on a substrate, wherein said RFID antenna pattern is conductive; and
depositing a layer of solderable material over said conductive element using vacuum metallization.

15. The method of claim 14 further comprising printing with a silver conductive ink a starting metallization pattern onto which electroplating can be applied.

16. The method of claim 14 wherein said layer of solderable material is deposited directly over said conductive coating.

17. The method of claim 14 wherein said layer of solderable material is deposited to completely cover said conductive coating.

18. A method of making an RFID antenna, comprising:
forming an RFID antenna pattern on a substrate, wherein said RFID antenna pattern is conductive;
depositing a layer of solderable material over said conductive element using vacuum metallization;
placing a chip on said solderable material;
heating said solderable material and said chip until said solderable material reaches a solderable material melting temperature; and
forming a weld joint between said solderable material and said chip.

19. The method of claim 18 wherein said heating comprises driving a current through said RFID antenna pattern.

20. The method of claim 18 further comprising printing with a silver conductive ink a starting metallization pattern onto which electroplating can be applied.

21. The method of claim 18 wherein said solderable material melting temperature is lower than a substrate melting temperature.

22. The method of claim 18 wherein said solderable material is heated to a temperature that is lower then a substrate glass transition temperature.

23. The method of claim 18 wherein said weld joint is formed by cooling said solderable material to below said solderable material melting temperature.

24. A method of making an RFID antenna, comprising:
forming an RFID antenna pattern on a substrate, wherein said RFID antenna pattern is electrically conductive;
depositing a layer of solderable material over said conductive element using vacuum metallization;
heating said solderable material to a solderable material melting temperature;
placing a chip on said solderable material while the temperature of the solderable material is near the solderable material melting temperature; and
forming a weld joint between said solderable material and said chip.

25. The method of claim 24 wherein said heating comprises driving a current through said RFID antenna pattern.

26. The method of claim 24 further comprising printing with a silver conductive ink a starting metallization pattern onto which electroplating can be applied.

27. The method of claim 24 wherein said solderable material melting temperature is lower than the substrate melting temperature.

28. The method of claim 24 wherein said solderable material is heated to a temperature that is lower then a glass transition temperature of said substrate.

29. The method of claim 24 wherein said weld joint is formed by cooling said solderable material to below said solderable material melting temperature.
